(19) United States
(12) Patent Application Publication
(10) Pub. No.: US 2017/0155715 A1
(43) Pub. Date: Jun. 1, 2017

(54) CLOUD STORAGE OF APPLICATIONS FOR MOBILE DEVICES

(71) Applicant: INTERNATIONAL BUSINESS MACHINES CORPORATION, Armonk, NY (US)

(72) Inventors: MAHARAJ MUKHERJEE, POUGHKEEPSIE, NY (US); MONIMALA MUKHERJEE, POUGHKEEPSIE, NY (US)

(21) Appl. No.: 14/955,143

(22) Filed: Dec. 1, 2015

(51) Int. Cl. H04L 29/08; H04M 1/725

(52) U.S. Cl. CPC H04L 67/1095; H04M 1/72522

(57) ABSTRACT

Embodiments include storing of applications for a mobile device in a cloud storage system. Aspects include monitoring a usage of an application installed on a mobile device and determining based on the usage of the application whether the application is a candidate for storage in the cloud storage system. Based on a determination that the application is the candidate for storage in the cloud storage system, aspects include transmitting at least a portion of the application to the cloud storage system. Aspects also include monitoring a usage of the mobile device and a context of the mobile device and responsively determining, that a local copy of the application is required by the mobile device. Aspects include downloading the at least a portion of the application from the cloud storage system based on determining that the local copy of the application is required by the mobile device.

### BACKGROUND

The present disclosure relates to the storage of applications for mobile devices and more specifically, to methods, systems and computer program products for storing applications for mobile devices in the cloud and similar distributed storage systems. Herein, we refer to cloud and similar distributed storage systems as cloud storage system.

The use of smartphones, tablets and other mobile devices has become ubiquitous. Users of mobile devices traditionally download numerous applications to their mobile device. These applications include, but are not limited to, games, productivity applications, new applications, travel applications, social networking applications and the like. Traditionally, mobile device users download and install a large number of applications on their mobile devices. Depending on the type of application, the application can take up a large amount of memory on the mobile device. For example, some applications can require a gigabyte or more of storage. In addition, some of these applications run in the background draining both battery as well as data bandwidth. Many users do not see deleting applications from their mobile devices as an option to free up storage space because since many of the applications cost money both during installation as well as re-installation. Furthermore, by removing the application and re-installing later, user data associated with the application is lost.

Existing methods are available for backing up applications installed on mobile device in cloud storage. However, such methods are designed to recover from an accidental deletion of the applications because the existing back-up methods do not store any personalization/customization that users make of the applications and they do not provide any method for automatically making additional storage space available on the mobile devices. Furthermore any customized dependencies create between multiple applications are also lost when this happens.

### SUMMARY

In accordance with an embodiment, a method for cloud storage of mobile applications is provided. The method includes monitoring a usage of an application installed on a mobile device and determining based on the usage of the application whether the application is a candidate for storage in the cloud storage system. Based on a determination that the application is the candidate for storage in the cloud storage system, the method includes transmitting at least a portion of the application to the cloud storage system. The method also includes monitoring one or more of a usage of the mobile device and a context of the mobile device and determining based on one or more of the usage of the mobile device and the context of the mobile device, that a local copy of the application is required by the mobile device. Based on a determination that the local copy of the application is required by the mobile device, the method includes downloading the at least a portion of the application from the cloud storage system.

In accordance with another embodiment, a mobile device configured to store applications in cloud storage is provided. The mobile device includes a processor in communication with one or more types of memory. The processor is configured to monitor a usage of an application installed on the mobile device and determine based on the usage of the application whether the application is a candidate for storage in the cloud storage system. Based on a determination that the application is the candidate for storage in the cloud storage system, the processor is configured to transmit at least a portion of the application to the cloud storage system. The processor is also configured to monitor one or more of a usage of the mobile device and a context of the mobile device and to determine based on one or more of the usage of the mobile device and the context of the mobile device, that a local copy of the application is required by the mobile device. Based on a determination that the local copy of the application is required by the mobile device, the processor is also configured to download the at least a portion of the application from the cloud storage system.

In accordance with a further embodiment, a computer program product for cloud storage of mobile applications includes a non-transitory storage medium readable by a processing circuit and storing instructions for execution by the processing circuit for performing a method. The method includes monitoring a usage of an application installed on a mobile device and determining based on the usage of the application whether the application is a candidate for storage in the cloud storage system. Based on a determination that the application is the candidate for storage in the cloud storage system, the method includes transmitting at least a portion of the application to the cloud storage system. The method also includes monitoring one or more of a usage of the mobile device and a context of the mobile device and determining based on one or more of the usage of the mobile device and the context of the mobile device, that a local copy of the application is required by the mobile device. Based on a determination that the local copy of the application is required by the mobile device, the method includes downloading the at least a portion of the application from the cloud storage system

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 is a block diagram illustrating one example of a processing system for practice of the teachings herein;

FIG. 4 is a block diagram illustrating a system for cloud storage of mobile applications in accordance with an exemplary embodiment;

FIG. 5 is a block diagram illustrating a memory of a mobile device in accordance with an exemplary embodiment; and

FIG. 6 is a flow diagram of a method for cloud storage of mobile applications in accordance with an exemplary embodiment.

### DETAILED DESCRIPTION

In accordance with exemplary embodiments of the disclosure, methods, systems and computer program products for cloud storage of mobile applications are provided. In exemplary embodiments, a mobile device, such as a smartphone or tablet, is configured to selectively store one or more applications in a cloud storage system to increase an available local storage on the mobile device. The mobile device is further configured to monitor the usage and context of the mobile device and to retrieve applications from the cloud storage system based on an anticipated usage of the applications by the mobile device. In exemplary embodiments, the storage and retrieval of applications in the cloud storage system is configured such that the user is not aware that the application has been stored remotely. In addition, any user data or customizations of the application installed on the mobile device are configured to remain on the mobile device, such that no change in the function or appearance of the application is notice when the application is stored in and retrieved from the cloud storage system.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

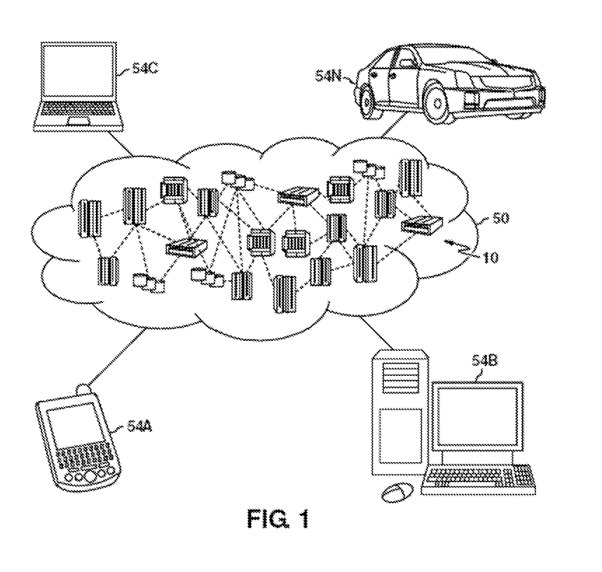

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

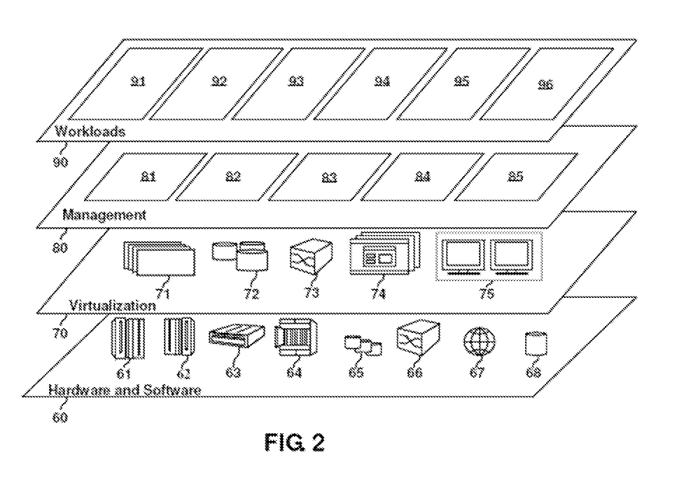

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and storage of applications for mobile devices 96.

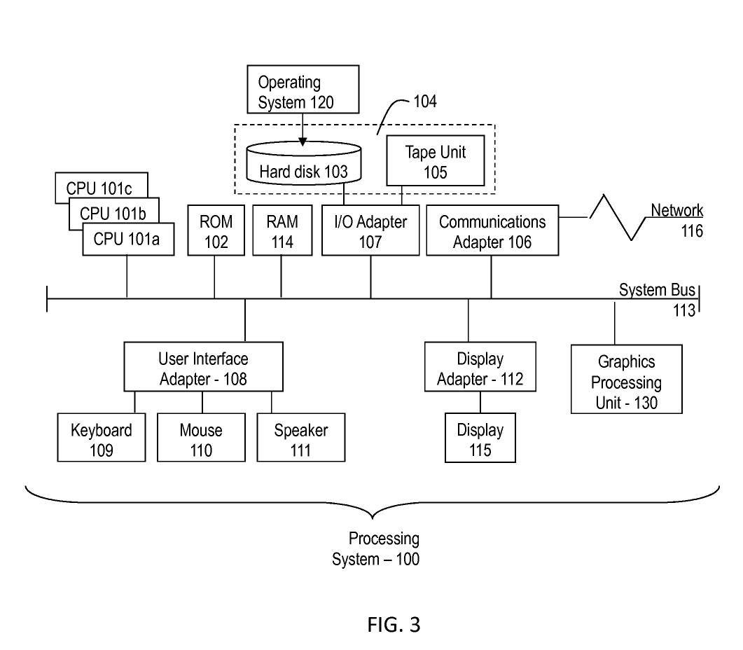

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 3.

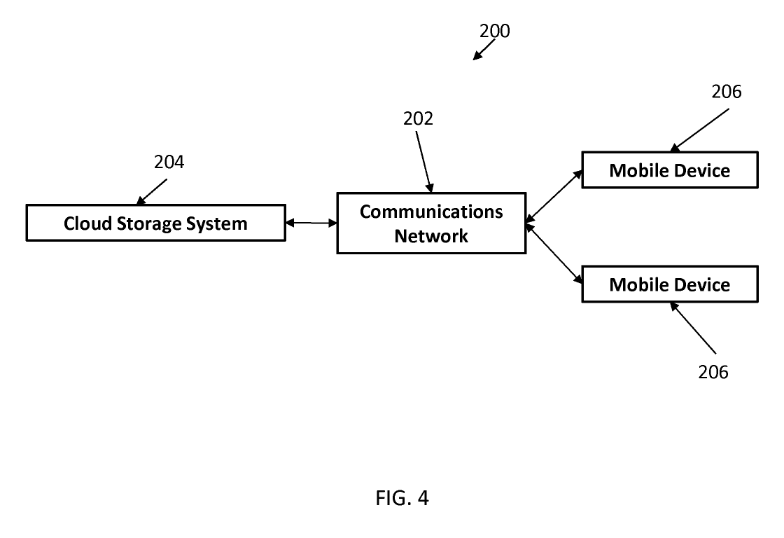

Referring now to FIG. 4, a system 200 for cloud storage of mobile applications is illustrated. As illustrated, the system 200 includes a cloud storage system 204 that is in communication with one or more mobile devices 206 via a communications network 202. In exemplary embodiments, the cloud storage system 204 can include any suitable cloud storage system known in the art. The system can be either completely a public cloud, or a private cloud or a hybrid cloud comprising of both private as well as public cloud. The communications network 202 can include, but is not limited to, a cellular communications network, a WiFi network, the Internet, or the like. The mobile devices 206 may be smartphones, smartwatches, tablets, or any other mobile computing device that is configured to execute user applications.

In exemplary embodiments, the mobile devices 206 are configured to selectively store one or more applications in the cloud storage system 204 to increase an available local storage on the mobile device 206. In one embodiment, the mobile device 206 monitors an amount of an available local storage on the mobile device 206 and monitors a usage pattern of the applications installed on the mobile device 206. Based on the amount of an available local storage, the usage pattern of the applications and the size of each of the applications installed, one or more applications are identified as candidates for storage in the cloud storage system.

In exemplary embodiments, candidate applications are identified based on a ranking of the applications. The rankings are based on a combination of one or more of a size of the application, a frequency of use of the application, how recently the application was last used, a pattern of use of the application, and the like. The pattern of use of the application may include a variety of information including a context of the mobile device during each use of the application, a time and date of each use of the application, and the like. In exemplary embodiments, based on an available storage of a mobile device falling below one or more threshold levels, one or more applications stored on the mobile device are transmitted to the cloud storage system. For example, when an available storage falls below a first threshold level, applications having a rank above a first value are selected to be moved to the cloud storage system. Likewise, when an available storage falls below a second threshold level, which is smaller than the first threshold level, applications having a rank above a second value are selected to be moved to the cloud storage system.

In exemplary embodiment, the mobile device anticipates the most suitable time to transfer outgoing or incoming data by following the pattern and location of the device with suitable communication such as mobile network coverage. For example, if the device is within suitable mobile network coverage during a time period every day, the system would wait for the data transfer for that time period.

In exemplary embodiments, the mobile devices 206 are further configured to monitor the usage and context of the mobile device 206 and to selectively retrieve applications from the cloud storage system 204 based on an anticipated usage of the applications by the mobile device 206. For example, if an application is typically used by a user once a week, for example every Saturday, the application may be stored in the cloud storage device all week and only retrieved and stored on the mobile device on Saturdays. In another example, a user may use a variety of travel related applications when they are traveling but may not use them during their normal daily activities. In this case, the mobile device may selectively store and retrieve the travel applications based on a determination that the user is going to be travailing, for example by accessing a user's calendar, email, social network application or the like. A wide variety of other potential uses will be apparent to one of ordinary skill in the art.

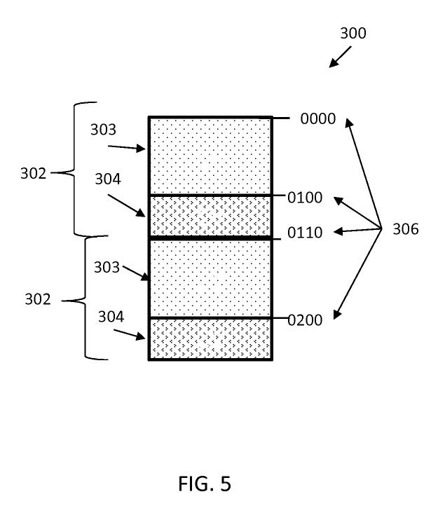

Referring now to FIG. 5, a block diagram illustrating a memory 300 of a mobile device in accordance with an exemplary embodiment is shown. As illustrated, the memory 300 that is used to store applications 302, which have been split into at least two parts 303 and 304. In exemplary embodiments, the first part 303 includes an executable part of the application and the second part 304 store user data 304 that are each associated with an application 302. For example, a first part 303 of a first application 302 is stored in address block 306 (0000-0100) and the second part 304, including user data associated with that application, is stored in address block 306 (0100-0110). In exemplary embodiments, user data or customizations of applications that have been installed on the mobile device are configured to remain on the mobile device after the application has been moved to the cloud storage system. As a result, when the application is re-installed on the mobile device no change in the function or appearance of the application is noticed by the user. In other words, when a first part 303 of an application 302 is transmitted to the cloud storage system, the second part 304 of the application remains on the mobile device.

In exemplary embodiments, the storage and retrieval of applications in the cloud storage system is configured such that the user is not aware that the application has been stored remotely. In general, when an application is installed on the mobile device an icon, or link, for the application is created in a user interface of the mobile device. In exemplary embodiments, the icon or link on the user interface for the application is configured to remain unchanged when the application is removed from the device and stored in the cloud storage system. In addition, when the application is retrieved from the cloud storage system, the link to the application can be re-directed to the application in its new location.

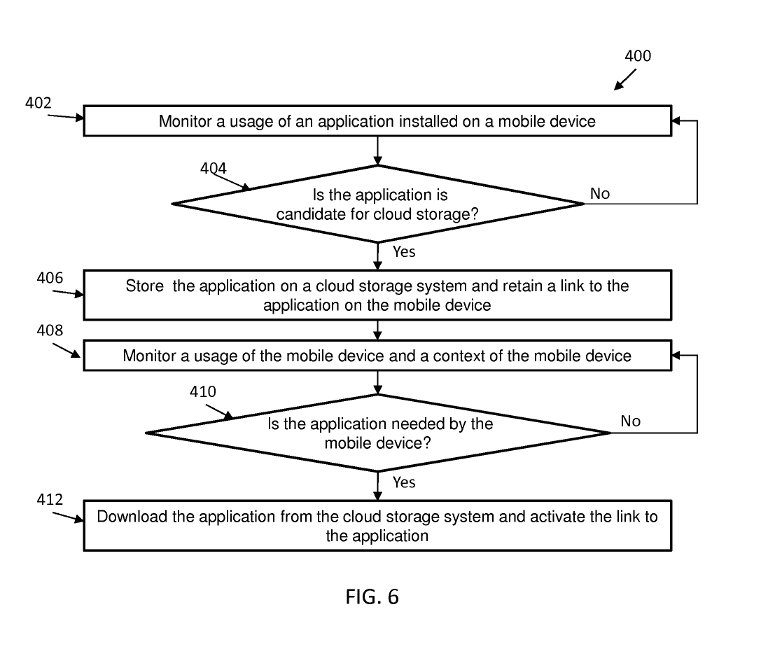

FIG. 6 is a flow diagram of a method 400 for cloud storage of mobile applications in accordance with an exemplary embodiment is shown. As shown at block 402, the method 400 includes monitoring a usage of an application installed on a mobile device. For example, a mobile device may keep a record of how often a user uses each application on the mobile device and may identify usage trends of the applications. Next, as shown at decision block 404, the method 400 includes determining if the application is candidate for cloud storage. In exemplary embodiments, this determination can be based on the monitored usage history of the application, the size of the application, the amount of storage available on the mobile device, and the like.

Once it is determined that an application is a candidate for storage in the cloud storage system, the method 400 includes storing the application on a cloud storage system and retaining a link to the application on the mobile device, as shown at block 406. In exemplary embodiments, any user data or customizations that are associated with the application are retained on the mobile device even though the application is stored in the cloud storage system. Next, as shown at block 408, the method 400 includes monitoring a usage of the mobile device and a context of the mobile device. The context of the mobile device can include, but is not limited to, a location of the mobile device, a time of day of an environment that the mobile device is located in, other applications being used by the mobile device, or the like.

As shown at decision block 410, the method 400 includes determining if the application needed by the mobile device. In exemplary embodiments, the determination if the application is needed by the mobile device is based on determining that the user is likely going to attempt to use the application in the near future, which can be based off of the monitored usage history of the mobile device, the context of the device, and the from other information sources. These other information sources may include a calendar of a user, an email account of a user, a social network of the user and the like. Once it is determined that the application is needed by the mobile device, the method 400 proceeds to block 412 and includes downloading the application from the cloud storage system and activating the link to the application.

In the current art, the applications installed in mobile devices are shipped in an object code form (a code in a machine readable form of 1s and 0s) that is optimized for the memory space. The operating system of the mobile device first connects or links all parts of the application to create a complete functional code and then finally combines all parts of the application in such a form that they cannot be separated from each other. Therefore, when an application is either deleted or backed up in the current art, it needs to be done for the whole program. In this way it loses any device and user specific personalization.

In exemplary embodiments, applications installed on a mobile device are split into two or more parts. In one embodiment, installed applications are divided into two parts, where the first part that includes executable code and a second part that includes user and device specific personalization. In general, the first part having the executable code will require more memory than the second part. In exemplary embodiments, each of these parts can be separately optimized for memory, but they are not optimized together. These two separate parts of the application are linked, or connected by a link map table, so that they can function as a whole. Accordingly, when an application is to be stored in the cloud storage system, only the first part of the application is stored in the cloud, leaving the second part of the application as well as the link map table stored on the mobile device. As a result, the user and the device specific personalization are not lost when the first part of the application transmitted to the cloud storage system.

In exemplary embodiment, the second part of the application is linked to a user selectable icon on the mobile device, that is persistent, i.e., it remains active on the user interface when the first part of the application is stored in the cloud storage system. Accordingly, the user is not aware that part of the application may be actually stored in the cloud storage system. When the user selects the icon, the second part of the application detects if the first part of the application is locally stored on the mobile device or not. If the first part of the application is available, the application functions as the way it is intended. If the first part of the application is not available then the second part of the application, instructs the device to fetch the first part of the application from the cloud mobile device, i.e., after it is fetched and stored back in the mobile device, the second part of the operating system of the mobile device re-links both parts of the application using the link map table and then the application can be executed in the normal manner as intended by the designer of the program.

Each programming language offers different methods and tools for creating and deploying a link map table as discussed above. The link map table is configured to link suitable and required sections of the second part of the application to the first part of the application so that they can function together. In case of JAVA script the link map table can be created using either symbolic or hard links. For example, this functionality is available in the java.nio.file package, and the Path class in particular, is “link aware.” Every Path method either detects what to do when a symbolic link is encountered, or it provides an option enabling you to configure the behavior when a symbolic link is encountered.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method for storing mobile device applications in a cloud storage system, the computer implemented method comprises:
monitoring a usage of an application installed on a mobile device;
determining based on the usage of the application whether the application is a candidate for storage in the cloud storage system;
based on a determination that the application is the candidate for storage in the cloud storage system, transmitting at least a portion of the application to the cloud storage system;
monitoring one or more of a usage of the mobile device and a context of the mobile device;
determining based on one or more of the usage of the mobile device and the context of the mobile device, that a local copy of the application is required by the mobile device; and
based on a determination that the local copy of the application is required by the mobile device, downloading the at least a portion of the application from the cloud storage system.

2. The computer implemented method of claim 1, further comprising:
based on a determination that the application is the candidate for storage in the cloud storage system, retaining a link to the application on a user interface of the mobile device.

3. The computer implemented method of claim 2, further comprising:
based on a determination that the local copy of the application is required by the mobile device, associating the link on the user interface to the application.

4. The computer implemented method of claim 1, wherein the determination that the application is the candidate for storage in the cloud storage system is further based on one or more an available storage capacity of the mobile device and a size of the application.

5. The computer implemented method of claim 1, further comprising:
based on a determination that the application is candidate for storage in the cloud storage system, saving, on the mobile device, user data associated with the mobile device.

6. The computer implemented method of claim 1, wherein the context of the mobile device includes one or more of a location of the mobile device and a time of day of an environment that the mobile device is located in.

7. The computer implemented method of claim 1, wherein monitoring the usage of the mobile device includes creating a usage profile for a user of the mobile device based on a historical usage pattern of the mobile device.

8. A computer program product for storing mobile device applications in a cloud storage system, the computer program product comprising:
a non-transitory storage medium readable by a processing circuit and storing instructions for execution by the processing circuit for performing a method comprising:
monitoring a usage of an application installed on a mobile device;
determining based on the usage of the application whether the application is a candidate for storage in the cloud storage system;
based on a determination that the application is the candidate for storage in the cloud storage system, transmitting at least a portion of the application to the cloud storage system;
monitoring one or more of a usage of the mobile device and a context of the mobile device;
determining based on one or more of the usage of the mobile device and the context of the mobile device, that a local copy of the application is required by the mobile device; and
based on a determination that the local copy of the application is required by the mobile device, downloading the at least a portion of the application from the cloud storage system.

9. The computer program product of claim 8, further comprising:
based on a determination that the application is the candidate for storage in the cloud storage system, retaining a link to the application on a user interface of the mobile device.

10. The computer program product of claim 9, further comprising:
based on a determination that the local copy of the application is required by the mobile device, associating the link on the user interface to the application.

11. The computer program product of claim 8, wherein the determination that the application is the candidate for storage in the cloud storage system is further based on one or more an available storage capacity of the mobile device and a size of the application.

12. The computer program product of claim 8, further comprising:
based on a determination that the application is candidate for storage in the cloud storage system, saving, on the mobile device, user data associated with the mobile device.

13. The computer program product of claim 8, wherein the context of the mobile device includes one or more of a location of the mobile device and a time of day of an environment that the mobile device is located in.

14. The computer program product of claim 8, wherein monitoring the usage of the mobile device includes creating a usage profile for a user of the mobile device based on a historical usage pattern of the mobile device.

15. A mobile device configured to store applications in a cloud storage system, the mobile device comprising a processor in communication with one or more types of memory, the processor configured to:
monitor a usage of an application installed on the mobile device;
determine based on the usage of the application whether the application is a candidate for storage in the cloud storage system;
based on a determination that the application is the candidate for storage in the cloud storage system, transmit at least a portion of the application to the cloud storage system;
monitor one or more of a usage of the mobile device and a context of the mobile device;
determine based on one or more of the usage of the mobile device and the context of the mobile device, that a local copy of the application is required by the mobile device; and
based on a determination that the local copy of the application is required by the mobile device, download the at least a portion of the application from the cloud storage system.

16. The mobile device of claim 15, wherein the processor is further configured to retain a link to the application on a user interface of the mobile device based on a determination that the application is the candidate for storage in the cloud storage system,.

17. The mobile device of claim 16, wherein the processor is further configured to associate the link on the user interface to the application based on a determination that the local copy of the application is required by the mobile device.

18. The mobile device of claim 15, wherein the determination that the application is the candidate for storage in the cloud storage system is further based on one or more an available storage capacity of the mobile device and a size of the application.

19. The mobile device of claim 15, wherein the processor is further configured to store, on the mobile device, user data associated with the mobile device based on a determination that the application is candidate for storage in the cloud storage system.

20. The mobile device of claim 15, wherein the context of the mobile device includes one or more of a location of the mobile device and a time of day of an environment that the mobile device is located in.
